(19) United States
(12) Patent Application Publication
(10) Pub. No.: US 2007/0059965 A1
(43) Pub. Date: Mar. 15, 2007

(54) Method and apparatus for non-contact grounding detection in an electrostatic paint system

(75) Inventors: John A. Scherschel, O'Fallon, IL (US); Gregory M. Kurwicki, Nashville, IL (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Magna International Inc.

(21) Appl. No.: 11/225,447

(22) Filed: Sep. 13, 2005

(51) Int. Cl. H01R 13/62

(52) U.S. Cl. 439/331

(57) ABSTRACT

A non-contact ground detection system and method for detecting a level of residual electrical charge of a part prior to application of paint during an electrostatic paint process. A charge generator is configured to apply an electrical charge to the part, and an electrostatic meter is configured for measuring a level of residual electrical charge on the part as the part moves away from the charge generator and toward the electrostatic meter. The measurement of the level of residual electrical charge is representative of the status of an electrical ground path from the part to an electrical ground.

### CROSS-REFERENCE TO RELATED APPLICATIONS

Not Applicable.

### STATEMENT REGARDING FEDERALLY SPONSORED RESEARCH

Not Applicable.

### BACKGROUND OF THE DISCLOSURE

The present disclosure relates to an electrical ground detection system, and in particular, to a non-contact electrical ground detection system that verifies the existence of an electrical path to ground by measuring the residual level of an electrical charge that is applied to a part just prior to an electrostatic paint process.

During an electrostatic painting process, a paint or coating is charged or ionized and sprayed onto a grounded part. The electrostatic attraction between the charged paint or coating and the grounded part draws the paint to the part, resulting in a more efficient painting process with less overspray which typically becomes wasted paint material. Electrostatic painting is particularly beneficial when the part has a complex shape, multiple openings, or is smaller than the effective spraying width of the equipment being used to apply the paint or coating.

Recently, there has been an emphasis on the use of polymeric or plastic materials in the manufacture of parts, particularly in automotive applications. The polymers typically used in such parts are insufficiently electrically conductive to generate the necessary difference in electrical potential to efficiently obtain a satisfactory paint thickness and coverage when the part is electrostatically painted. As such, polymeric parts require the application of an electrically conductive coating to assist in the paint process.

### BRIEF SUMMARY OF THE DISCLOSURE

Briefly stated, an embodiment of the present disclosure provides a non-contact electrical ground detection system that measures residual levels of an electrical charge applied to a part just prior to an electrostatic paint process. A non-contact ground detection system for detecting the residual electrical charge on a part includes a charge generator configured to apply an electrical charge to the part. An electrostatic meter is configured to measure the level of residual electrical charge as the part moves away from the charge generator and towards the electrostatic meter. The measurement of the level of the residual electrical charge verifies a ground path from the part to electrical ground.

A method of the present invention provides for measurement of a level of residual electrical charge on a part, coupled to a programmable logic controller. During operation, the part is electrically coupled to a conveyor by a ground clip. The part is coated with a conductive coating, and an electrical charge is applied to the part. The level of the residual electrical charge is measured by measuring the level of static electricity present on the part in order to verify existence of an electrical ground path from the part.

In an alternate embodiment, an output signal is generated corresponding to a measured level of static electricity present on a part just prior to an electrostatic paint process, and is compared to a predetermined level of residual electric charge. A first signal is generated when the output signal has a value less than the predetermined level of residual electrical charge. A second signal is generated when the output signal has a value between two predetermined levels of residual electrical charge. Finally a third signal is generated when the output signal is greater than a predetermined level of residual electrical charge.

The foregoing and other objects, features, and advantages of the disclosure as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a side elevation view of a non-contact ground detection system of the present invention illustrating a charge generator and an electrostatic meter;

FIG. 2 is a schematic view of an alternate non-contact ground detection system of the present invention illustrating a charge generator, an electrostatic meter, a static monitor and a controller; and

FIG. 3 is a flowchart illustrating a method of the present invention for detecting a grounding path just prior to an electrostatic painting process.

Corresponding reference numerals indicate corresponding parts throughout the several figures of the drawings.

### DESCRIPTION OF THE PREFERRED EMBODIMENT

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

In a first embodiment, a non-contact ground detection system of the present invention is configured to identify if an electrical ground contact with a part is achieved just prior to an electrostatic painting process by verifying the existence of an electrical ground path from the part in a non-contact manner, and is optionally automated to monitor the grounding path in a hazardous environment. The non-contact ground detection system of the present invention is optionally configured to monitor multiple product lines consisting of different parts, while providing a feedback signal representative of the grounding path for any particular part.

In electrostatic painting of certain parts, problems may arise if the part to be painted can not send the charge produced by the paint applicator to an electrical ground. There is a risk of an uncontrolled electrical discharge that could result in an operator receiving an electrical shock and/or the production of a hazardous situation if flammable solvents are present (e.g. as part of the formulation being applied). Furthermore, an inability to send the electrical charge produced by the applicator to electrical ground may result in inefficient paint processes. These risks and inefficiencies can be minimized by ensuring that there is good electrical continuity for the part being painted, for instance, by making an electrical connection to the part to provide an electrical ground path for the part. As such, a non-contact ground detection system of the present disclosure verifies the existence of a path to an electrical ground.

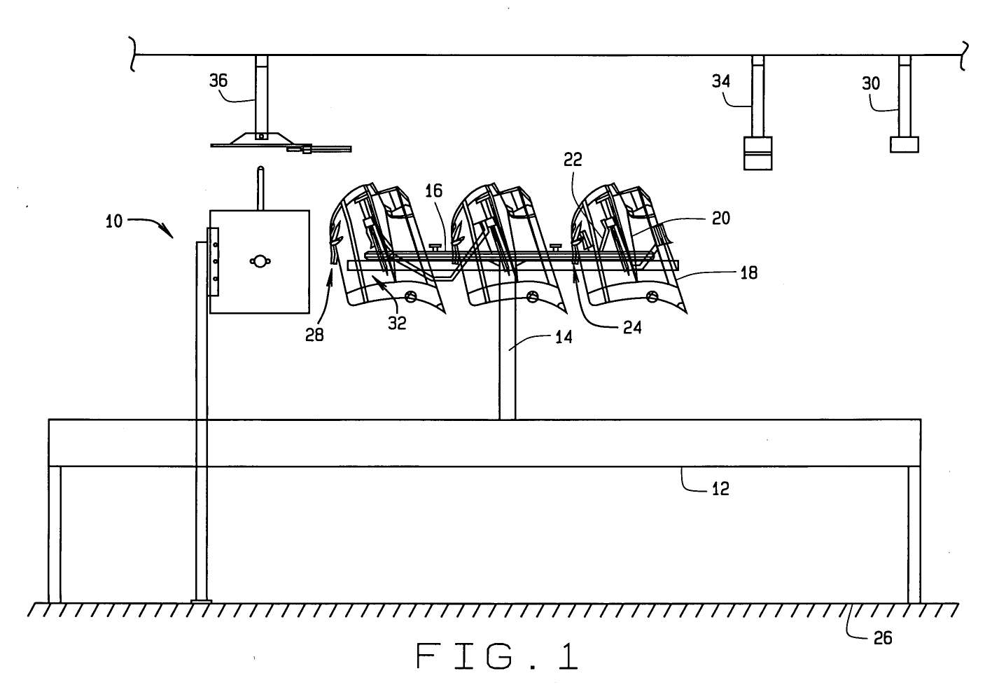

Turning to FIG. 1, the ground detection system is generally shown as 10. A moving system 12 such as a conveyor may operatively connect to at least one stand 14. Each stand 14 has an arm 16 which holds at least one part 18. Part 18 fits on top of a form fitting buck 20 such that the inside of the part 18 rests on the outside of the buck 20. As known in the art, buck 20 is a support having the same shape as the part 18. The buck 20 connects to the arm 16 of the stand 14 via an extension 22 such that the buck 20 suspends the part 18 away from the arm 16. The conveyor 12 is configured to move the part 18 as needed during the electrostatic paint process.

In an embodiment, the backside of the buck 20, extension 22, arm 16, stand 14 and conveyor 12 comprises metal material. As such, the ground detection system 10 incorporates a ground path 24 to electrical ground 26, such as an electrical ground, from the buck 20 and through the conveyor 12 via the extension 22, the arm 16 and stand 14. Ground clips 28, meanwhile, attach to the outside portion of the part 18 and attach to the top side of the buck 20 to electrically couple the part 18 to the buck 20. Accordingly, the part 18 is electrically coupled to the conveyor 12. In FIG. 1, ground path 24 is generally shown as reference numeral 24 which relates to the electrical connection of the part 18 to the electrical ground 26 via the ground clip 28, the buck 20, the extension 22, the arm 16, the stand 14 and conveyor 12.

As shown in FIG. 1, a coating applicator 30 is configured for applying a conductive coating 32 to the part 18. The coating applicator 30 may apply the conductor coating 32 to the outside portion of the part 18. The ground detection system 10 comprises a charge generator 34 which is configured for applying an electrical charge to the part 18 after the conductive coating 32 has been applied to the part 18. In an embodiment, the charge generator 34 may comprise an ion generator or a paint gun. Additionally, the ground detection system 10 comprises an electrostatic meter 36 which is configured for measuring a residual amount of the electrical charge applied to the part 18 as the conveyor 12 moves the part 18 away from the charge generator 34 and toward the electrostatic meter 36 such that the measurement of the residual amount of the electrical charge verifies the ground path 24 from the part 18 to electrical ground 26. Preferably, the electrostatic meter 36 is adapted to withstand hazardous environmental conditions.

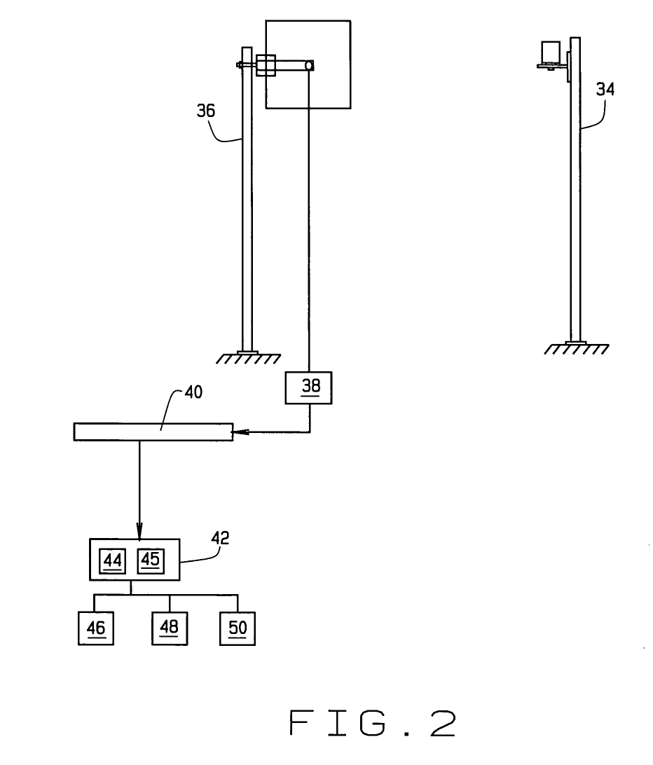

Referring to FIG. 2, the ground detection system 10 is shown in a schematic view, wherein the electrostatic meter 36 is configured for non-contact measurement of the residual amount of the electrical charge of the part 18 (FIG. 1) by continuously measuring static electricity levels present on the part 18. Electrostatic meter 36 is configured to generate an output signal 38 corresponding to the measured level of static electricity present on the part 18.

A static monitor 40 is connected to the electrostatic meter 36. The static monitor 40 is configured to convert the output signal 38 of the electrostatic meter 36 into a suitable standard value, such as kilovolts. A controller 42 in communication with the static monitor 40 is configured to compare the output value to a range created by two different predetermined levels of residual electrical charge 44 and 45, as will be discussed. The controller 42 generates a first signal 46 when the output signal 38 has a value greater than the upper predetermined level of residual electrical charge 45. A second signal 48 is generated when the output signal 38 has a value equal to or greater than the lower predetermined level of residual electrical charge 44 and equal to or less than the upper predetermined level of residual electrical charge 45. The third signal 50 is generated when the output signal 38 has a value less than the lower predetermined level of residual electrical charge 44. In an embodiment, the controller 42 may convert the output signal 38 to the standard value.

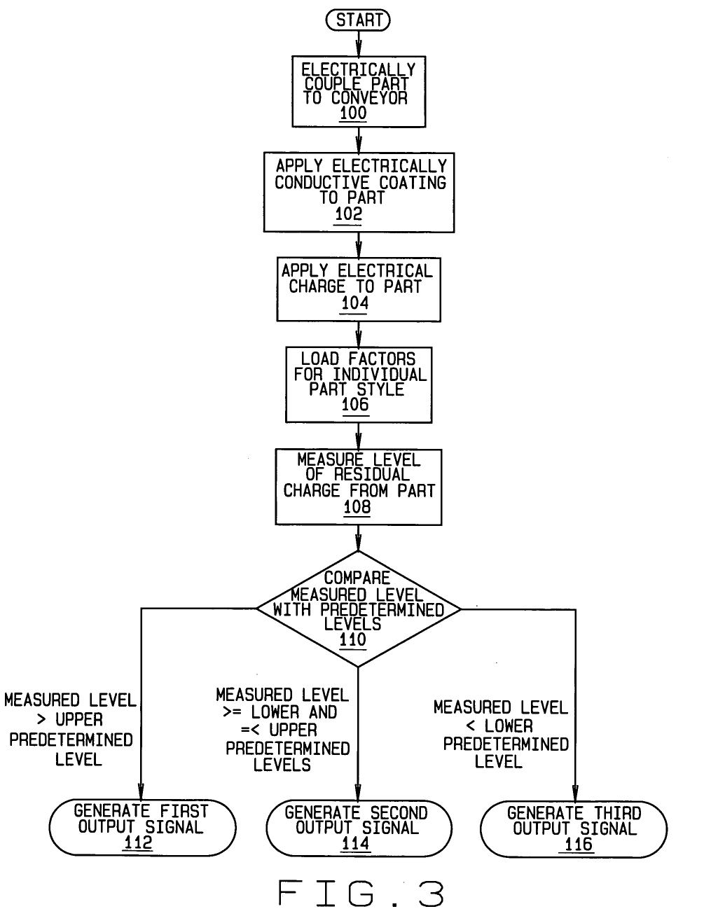

Turning to FIG. 3 and referring to FIGS. 1 and 2, during operation, the non-contact ground detection system measures the level of residual electrical charge of the part 18 to verify the existence of the ground path 24 to electrical ground 26. Initially, the user, or an automatic operation such as an assembly robot, electrically couples the part 18 to the conveyor 12 to provide a pathway to an electrical ground (Box 100). As shown in FIG. 1, multiple parts 18 may be coupled to stand 14 by multiple form fitting bucks 20. A coating applicator 30 coats the part 18 with an electrically conductive coating 32 prior to the application of the electrical charge (Box 102).

The part 18 is next moved towards the charge generator 34, which applies an electrical charge to the part 18 (Box 104). The factors needed to convert the measured levels of residual electrical charge to a standard measurement are then loaded into the controller 42 (Box 106).

The conveyor 12 then conveys the part 18 toward the electrostatic meter 36, which measures the level of residual electrical charge by measuring the level of static electricity present on the part 18 (Box 108). The electrostatic meter 36 generates the output signal 38 corresponding to the measured static electricity level. The electrostatic meter 36 communicates the output signal 38 to the static monitor 40 which converts the output signal 38 to a standard value and subsequently communicates the output signal to the controller 42. As previously noted the controller 42 utilizes the output signal 38 directly and converts the raw output signal 38 to an appropriate standard via the loaded factors which are determined by the physical characteristics of the part 18 such as, but not limited to, size, shape, and material composition, with the use of the static monitor 40.

The controller 42 evaluates the converted output signal 38 by comparison with predetermined levels of residual charge 44 and 45 (Box 110). If the electrical charge of the part 18 dissipates completely, or the output signal 38 has a value greater than the upper predetermined level of residual charge 45, the controller generates a first signal 46 (Box 112) to notify the operator that the ground path 24 to electrical ground 26 exists for the part 18 and that the ground clip 28 has properly connected the part 18 to the buck 20. Thus, measuring the residual electrical charge verifies the existence of ground path 24 to electrical ground 26 by the conductive coating 32 and the ground clips 28.

If the output signal 38 has a value equal to or greater than the lower predetermined level of residual charge 44 and equal to or less than the upper predetermined level of residual charge 45, the controller 38 generates the second signal 48 (Box 114) to notify the operator that the ground path 24 to electrical ground 26 is inadequate.

The third signal 50 is generated when the output signal 38 is less than the lower predetermined level of residual charge, indicating to the operator that either the conductive coating 32 has not been adequately applied to the part 18, or that the ground clip 28 is missing or not making proper contact to couple the part 18 and the buck 20. When the controller 42 generates the third signal 50, the operator preferably inspects the part 18 before transferring the part 18 to the electrostatic paint process (not shown).

In view of the above, it will be seen that the several objects of the disclosure are achieved and other advantageous results are obtained. As various changes could be made in the above constructions without departing from the scope of the disclosure, it is intended that all matter contained in the above description or shown in the accompanying drawings shall be interpreted as illustrative and not in a limiting sense.

1. A non-contact ground detection system for detecting a residual electrical charge on a part which is electrically coupled to an electrical ground, comprising:
a charge generator configured for applying an electrical charge to said part; and
an electrostatic meter displaced from said charge generator, said electrostatic meter configured to measure a residual level of said electrical charge applied to said part as said part is moved away from said charge generator and towards said electrostatic meter.

2. The non-contact ground detection system of claim 1 wherein said residual level of said electrical charge is responsive to a ground path from said part to said electrical ground.

3. The non-contact ground detection system of claim 1 wherein said electrostatic meter is configured for non-contact measurement of said residual level of said electrical charge on said part.

4. The non-contact ground detection system of claim 1 wherein said electrostatic meter is configured to measure the residual level of said electrical charge by measuring a level of static electricity present on said part.

5. The non-contact ground detection system of claim 4 wherein said electrostatic meter is configured to continuously measure a level of static electricity present on said part.

6. The non-contact ground detection system of claim 4 wherein said electrostatic meter is configured to generate at least one output signal responsive to the measured level of static electricity present on said part.

7. The non-contact ground detection system of claim 5 further comprising a static monitor in communication with said electrostatic meter, said static monitor configured to convert said output signal into a standard value.

8. The non-contact ground detection system of claim 7 further comprising a controller in communication with said static monitor, said controller configured to compare said standard value to at least one predetermined level of residual electrical charge.

9. The non-contact ground detection system of claim 4 further comprising a controller in communication with said electrostatic meter, said controller configured to compare said measured level of static electricity present on said part represented by said output signal to at least one predetermined level of residual electrical charge.

10. The non-contact ground detection system of claim 1 further comprising a conveyor which is configured to move said part from said charge generator towards said electrostatic meter, said conveyor electrically coupled to said electrical ground.

11. The non-contact ground detection system of claim 1, further comprising a coating applicator configured for applying a conductive coating to the part prior to said application of said electrical charge.

12. A method for detecting a residual electrical charge on a part prior to an electrostatic paint process, comprising:
electrically coupling said part to a conveyor;
applying an electrical charge to said part; and
measuring a residual level of said electrical charge as said conveyor moves said part.

13. The method of claim 12 for detecting a residual electrical charge on a part wherein electrically coupling said part to said conveyor comprises attaching said part to said conveyor by a ground clip.

14. The method of claim 12 for detecting a residual electrical charge on a part wherein measuring said residual level of said electrical charge includes measuring a level of static electricity present on said part.

15. The method of claim 14 for detecting a residual electrical charge on a part further including the step of generating an output signal corresponding to said measured level of static electricity present on said part.

16. The method of claim 15 for detecting a residual electrical charge on a part further including the step of comparing said output signal to a representation of at least one predetermined level of residual charge.

17. The method of claim 15 for detecting a residual electrical charge on a part further including the step of generating a first signal when said output signal represents a measured level of static electricity which is greater than a predetermined level of residual charge.

18. The method of claim 17 for detecting a residual electrical charge on a part further including the step of generating a second signal when said output signal represents a measured level of static electricity which is equal to or greater than a lower predetermined level of residual charge and equal to or less than an upper predetermined level of residual charge.

19. The method of claim 18 for detecting a residual electrical charge on a part further including the step of generating a third signal when said output signal represents a measured level of static electricity which is less than said predetermined lower level of residual charge.

20. The method of claim 14 for detecting a residual electrical charge on a part further including the step of comparing said measured level of static electricity to a plurality of predetermined levels of residual electrical charge.

21. The method of claim 20 for detecting a residual electrical charge on a part further including the step of generating a first signal when said measured level of static electricity is greater than a predetermined upper level of residual electrical charge;
generating a second signal when said measured level of static electricity is equal to or greater than a predetermined lower level of residual charge and equal to or less than said predetermined upper level of residual electrical charge; and
generating a third signal when said measured level of static electricity is less than said predetermined lower level of residual electrical charge.

22. The method of claim 12 for detecting a residual electrical charge on a part wherein sad step of measuring a residual level of said electrical charge verifies a status of an electrical ground path from said part to an electrical ground as said conveyor moves said part.

23. The method of claim 12 further including the step of coating said part with a conductive coating prior to application of said electrical charge to said part.

24. A method for detecting a level of a residual electrical charge on a part coupled to a conveyor during an electrostatic paint process, comprising:
electrically coupling the part to the conveyor;
coating the part with a conductive coating;
applying an electrical charge to the part;
measuring a level of residual electrical charge on the part by measuring a level of static electricity present on the part, said level of residual electrical charge responsive to the condition of an electrical ground path from the part to an electrical ground; and
generating an output signal representative of said measured level of static electricity present on the part.

25. The method of claim 24 for detecting a level of a residual electrical charge on a part further including the step of comparing said output signal with a representation of a predetermined level residual electrical charge.

26. The method of claim 24 for detecting a level of a residual electrical charge on a part further including the steps of generating a first signal when said output signal represents a measured level of static electricity present on the part which is greater than a predetermined upper level of residual charge;
generating a second signal when said output signal represents a measured level of static electricity present on the part which is equal to or greater than a predetermined lower level of residual charge and equal to or less than said predetermined upper level of residual charge; and
generating a third signal when said output signal represents a measured level of static electricity present on the part which is less than said predetermined lower level of residual charge.
